(19) United States
(12) Patent Application Publication
(10) Pub. No.: US 2019/0196350 A1
(43) Pub. Date: Jun. 27, 2019

(54) TONER, TONER CONTAINER, DEVELOPING UNIT, AND IMAGE FORMING APPARATUS

(71) Applicant: Oki Data Corporation, Tokyo (JP)

(72) Inventor: Hideharu KUWABARA, Tokyo (JP)

(21) Appl. No.: 16/227,491

(22) Filed: Dec. 20, 2018

(30) Foreign Application Priority Data
Dec. 26, 2017 (JP) 2017-248849

(51) Int. Cl. G03G 9/09; G03G 9/087; G03G 9/08; G03G 15/08

(52) U.S. Cl. CPC G03G 9/0926; G03G 9/08755; G03G 15/0867; G03G 9/0902; G03G 9/0804

(57) ABSTRACT

A toner includes a brilliant pigment and binder resin. The toner has a weight-average molecular weight that is equal to or greater than 19601 and equal to or smaller than 55938.

### CROSS REFERENCE TO RELATED APPLICATIONS

The present application claims priority from Japanese Patent Application No. 2017-248849 filed on Dec. 26, 2017, the entire contents of which are hereby incorporated by reference.

### BACKGROUND

The technology relates to a toner including a brilliant pigment, a toner container using the toner, a developing unit using the toner, and an image forming apparatus using the toner.

An image forming apparatus using an electrophotographic method is in widespread use. One reason for this is that the image forming apparatus using the electrophotographic method is able to achieve a higher-quality image in a shorter time, compared with an image forming apparatus using other methods such as an inkjet method.

The image forming apparatus using the electrophotographic method forms an image on a print medium using a toner. In a process of forming the image, the toner attached to an electrostatic latent image is transferred onto the print medium, and thereafter, the toner is fixed to the print medium.

In order to form an image having brilliant characteristics, a toner having brilliant characteristics is used. The toner having brilliant characteristics includes a brilliant pigment. Related to the toner including the brilliant pigment, various proposes have been made.

For example, in order to form an image having characteristics such as high brilliant characteristics, endothermic characteristics of the toner including the brilliant pigment is made appropriate, for example, as disclosed in Japanese Unexamined Patent Application Publication No. 2016-186519. In this case, an endothermic amount at the maximum peak at the second increase in temperature is set to fall within an appropriate range. The endothermic amount is measured by means of a differential scanning calorimetry (DSC).

### SUMMARY

Various considerations have been made related to a toner having brilliant characteristics; however, quality of an image having the brilliant characteristics has not been sufficiently high yet, which still leaves room for improvement. It may be important not only to improve quality of an image but also to form the image with stability.

It is desirable to provide a toner, a toner container, a developing unit, and an image forming apparatus that each make it possible to form, with stability, a higher-quality image having brilliant characteristics.

According to one embodiment of the technology, there is provided a toner that includes a brilliant pigment and binder resin. The toner has a weight-average molecular weight that is equal to or greater than 19601 and equal to or smaller than 55938.

According to one embodiment of the technology, there is provided a toner container that includes a toner containing unit. The toner containing unit contains a toner. The toner includes a brilliant pigment and binder resin. The toner has a weight-average molecular weight that is equal to or greater than 19601 and equal to or smaller than 55938.

According to one embodiment of the technology, there is provided a developing unit that includes a toner container and a developing process unit. The toner container includes a toner containing unit. The toner containing unit contains a toner. The toner includes a brilliant pigment and binder resin. The toner has a weight-average molecular weight that is equal to or greater than 19601 and equal to or smaller than 55938. The developing process unit performs a developing process with use of the toner contained in the toner container.

According to one embodiment of the technology, there is provided an image forming apparatus that includes a developing unit, a transfer section, and a fixing section. The developing unit includes a toner container and a developing process unit. The toner container includes a toner containing unit. The toner containing unit contains a toner. The toner includes a brilliant pigment and binder resin. The toner has a weight-average molecular weight that is equal to or greater than 19601 and equal to or smaller than 55938. The developing process unit performs a developing process with use of the toner contained in the toner container. The transfer section performs a transfer process with use of the toner on which the developing process has been performed by the developing unit. The fixing section performs a fixing process with use of the toner on which the transfer process has been performed by the transfer section.

According to one embodiment of the technology, there is provided a method of manufacturing a toner. The method includes: preparing an oil phase including a brilliant pigment, binder resin, and an organic solvent; preparing an aqueous phase including an inorganic dispersant and an aqueous medium; performing granulation of a toner base particle by mixing the oil phase and the aqueous phase; and manufacturing the toner with use of the toner base particle, the toner having a weight-average molecular weight that is equal to or greater than 19601 and equal to or smaller than 55938.

### BRIEF DESCRIPTION OF DRAWINGS

FIG. 1 is a schematic perspective view of an example of a configuration of a brilliant pigment.

FIG. 2 is a plan view of an example of a configuration of an image forming apparatus according to one example embodiment of the technology.

FIG. 3 is an enlarged plan view of an example of a configuration of a developing unit illustrated in FIG. 2.

FIG. 4 is a plan view of a modification example related to the configuration of the image forming apparatus.

### DETAILED DESCRIPTION

Hereinafter, some example embodiments of the technology will be described in detail with reference to the drawings. Note that the following description is directed to illustrative examples of the technology and not to be construed as limiting to the technology. Factors including, without limitation, numerical values, shapes, materials, components, positions of the components, and how the components are coupled to each other are illustrative only and not to be construed as limiting to the technology. Further, elements in the following example embodiments which are not recited in a most-generic independent claim of the technology are optional and may be provided on an as-needed basis. The drawings are schematic and are not intended to be drawn to scale. Note that the like elements are denoted with the same reference numerals, and any redundant description thereof will not be described in detail. The description will be given in the following order.
1. Toner
   1-1. Configuration
   1-2. Physical Property
   1-3. Manufacturing Method
   1-4. Example Workings and Example Effects
2. Image Forming Apparatus (Toner Container and Developing Unit)
   2-1. General Configuration
   2-2. Configuration of Developing Unit
   2-3. Operation
   2-4. Example Workings and Example Effects
3. Modification Examples

### 1. TONER

A description is given first of a toner according to an example embodiment of the technology.

The toner described below may be used to form an image having brilliant characteristics. In other words, the toner described below may be a toner having the brilliant characteristics. The image having the brilliant characteristics is hereinafter simply referred to as a “brilliant image”. The toner having the brilliant characteristics is hereinafter simply referred to as a “brilliant toner”.

The brilliant toner is not particularly limited in its application. For example, the brilliant toner may be used in an image forming apparatus such as that using an electrophotographic method, as will be described later. Non-limiting examples of the image forming apparatus using the electrophotographic method may include a laser printer. The brilliant toner used in the laser printer may be, for example, a so-called electrostatic development toner.

The brilliant toner may be, for example, a negatively-charged toner of a single component development method. In other words, the brilliant toner may have a negative charging polarity, for example. The single component development method provides the brilliant toner itself with an appropriate amount of electric charge without using a carrier, e.g., a magnetic particle, to apply an electric charge to the brilliant toner. In contrast, a two-component development method provides the brilliant toner with an appropriate amount of electric charge by mixing the foregoing carrier and the brilliant toner with each other and thereby utilizing friction between the carrier and the brilliant toner.

### [1-1. Configuration]

A description is given first of an example of a configuration of the brilliant toner.

The brilliant toner includes a brilliant pigment and binder resin. It is to be noted that the brilliant toner may include only one type of brilliant pigment, or may include two or more types of brilliant pigments. The brilliant toner may also include only one type of binder resin, or may include two or more types of binder resin.

The brilliant toner is not particularly limited in its color as long as the brilliant toner has a color having the brilliant characteristics. Non-limiting examples of the color of the brilliant toner may include colors of gold, silver, and copper.

### [Brilliant Pigment]

The brilliant pigment may be a material that provides the brilliant characteristics to the brilliant toner.

### [Composition]

The brilliant pigment may include one or more of brilliant materials. The term “brilliant material” refers to a material having the brilliant characteristics and insolubility. The brilliant characteristics provides brilliance such as metallic brilliance. The insolubility is characteristics insoluble to a solvent such as an organic solvent.

Non-limiting examples of the brilliant material may include aluminum (Al) and a pearlescent pigment. Non-limiting examples of the pearlescent pigment may include a thin-flake-shaped inorganic crystalline substrate covered with titanium dioxide (TiO₂).

It is to be noted that the brilliant pigment may include any component having a small amount. For example, in a case where the brilliant pigment includes aluminum, the brilliant pigment may include any component having a small amount as long as the brilliant pigment includes aluminum as its major component. In other words, a content or purity of aluminum in the brilliant pigment is not necessarily 100% but may be less than 100%. One reason for this is that sufficient brilliant characteristics are allowed to be obtained when the brilliant pigment includes aluminum as its major component.

### [Three-Dimensional Shape]

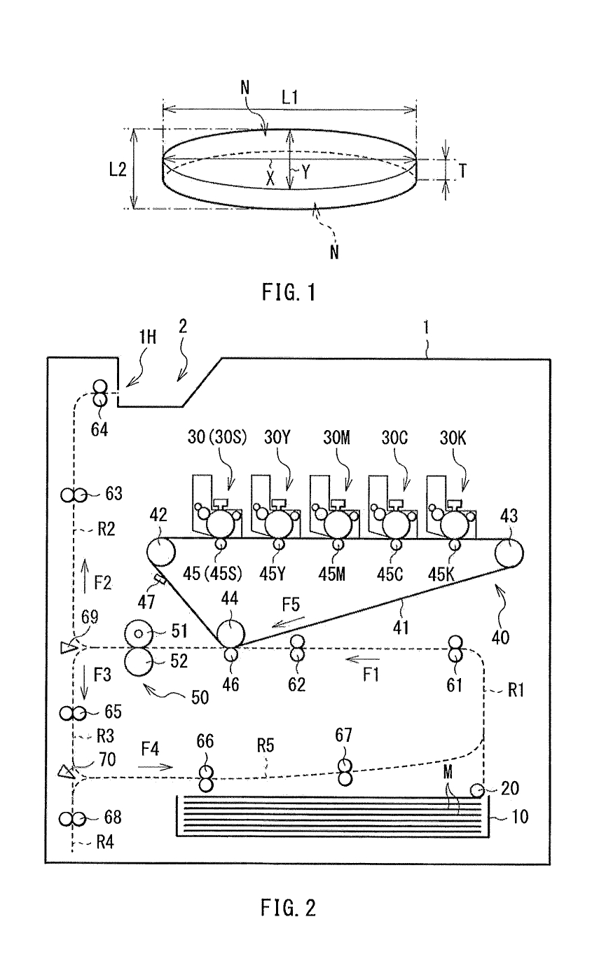

FIG. 1 schematically illustrates an example of a perspective configuration of the brilliant pigment. The brilliant pigment is not particularly limited in its three-dimensional shape. In one example, the brilliant pigment may include a plurality of flat particles as illustrated in FIG. 1. One reason for this is that higher brilliant characteristics are allowed to be obtained thereby.

Each of the flat particles of the brilliant pigment may have a major axis X, a minor axis Y, and a thickness T, for example. In other words, each of the flat particles of the brilliant pigment may have a pair of surfaces N having a substantially-elliptic shape specified by the major axis X and the minor axis Y. A distance between the pair of surfaces N, i.e., the thickness T, may be sufficiently smaller than each of a length L1 of the major axis X and a length L2 of the minor axis Y.

The series of dimensions related to the flat particles of the brilliant pigment are not particularly limited. The “series of dimensions” described herein include an average thickness TA of the flat particles of the brilliant pigment, an average length L1A of the major axes of the respective flat particles of the brilliant pigment, and an average length L2A of the minor axes Y of the respective flat particles of the brilliant pigment.

In one example, the average thickness TA of the flat particles of the brilliant pigment may be equal to or greater than about 0.1 μm and equal to or smaller than about 1 (one) μm. In one example, the average length L1A of the major axes X may be equal to or greater than about 5 μm and equal to or smaller than about 20 μm both inclusive. In one example, the average length L2A of the minor axes Y may be from about 2 μm to about 12 μm. One reason for these is that sufficient brilliant characteristics are allowed to be obtained thereby.

A procedure to calculate each of the average thickness TA, the average length L1A, and the average length L2A described above may be as the following, for example.

In a case of calculating the average thickness TA, first, the flat particles of the brilliant pigment may be cut in a direction of the thickness T. Thereby, a cross-section of the flat particles of the brilliant pigment may he exposed. The cutting of the flat particles of the brilliant pigment may be performed by means of an equipment such as a microtome having a diamond knife. Thereafter, the cross-sections of the flat particles of the brilliant pigment may be observed by means of a microscope such as a scanning electron microscope (SEM). Thereafter, the thicknesses T of any fifty particles selected from the cut flat particles of the brilliant pigment may be measured on the basis of a result of the observation, e.g., a microscope photograph. Thereafter, the average thickness TA, i.e., an average value of the measured thicknesses T of the selected fifty particles of the brilliant pigment may be calculated.

In a case of calculating the average length L1A, first, the brilliant pigment may be put into a surfactant. The surfactant may be, for example but not limited to, Emulgen (registered trademark) 109P available from Kao Corporation, located in Tokyo, Japan. Thereafter, the surfactant with the brilliant pigment may be stirred, thereby obtaining a dispersion liquid in which the brilliant pigment is dispersed in the surfactant. Thereafter, the dispersion liquid may be dropped on a cover glass, following which the brilliant pigment in the dispersion liquid may be observed by means of a microscope such as a digital microscope. The observation of the brilliant pigment may be performed, for example, at 1000-fold magnification. The microscope may be, for example, a digital microscope VH-5500 available from Keyence Corporation, located in Osaka, Japan. In the case of performing the observation described above, a zoom lens may be used as an observation lens, and a transparent illumination may be used as a light source. The zoom lens may be, for example, a high-resolution zoom lens VH-500 available from Keyence Corporation, located in Osaka, Japan. In this observation, light emitted from the light source may be blocked by the brilliant pigment. Therefore, the brilliant pigment may be observed as a black object. Thereafter, the lengths L1 of any fifty particles selected from the brilliant pigment may be measured on the basis of a result of the observation, e.g., a microscope photograph. Thereafter, the average length L1A, i.e., an average value of the measured lengths L1 of the selected fifty particles of the brilliant pigment may be calculated.

A procedure to calculate the average length L2A may be similar to the above-described procedure to calculate the average length L1A except that the lengths L2 may be measured instead of the lengths L1 and the average length L2A may be calculated instead of the average length L1A.

### [Content]

A content of the brilliant pigment in the brilliant toner is not particularly limited. In one example, the content of the brilliant pigment in the brilliant toner may be equal to or greater than about 10 wt % and equal to or smaller than about 30 wt %. In another example, the content of the brilliant pigment in the brilliant toner may be equal to or greater than about 15 wt % equal to or smaller than about 25 wt %. One reason for this is that brilliant characteristics and electric charge characteristics of the brilliant toner are improved thereby.

### [Binder Resin]

The binder resin may bind substances such as the brilliant pigment with each other. The binder resin may include one or more of polymer compounds such as polyester-based resin, styrene-acrylic-based resin, epoxy-based resin, or styrene-butadiene-based resin. A crystalline state of the polymer compound is not particular limited. Therefore, the polymer compound may be crystalline or may be amorphous.

The term “polyester-based resin” described above collectively refers to polyester and a derivative thereof. As described above, a term including the wording “-based” collectively refers to the material recited immediately before “-based” and its derivative. This is similarly applicable to a term that includes the wording “-based” and is related to resin other than the polyester-based resin. This is also similarly applicable to a term that includes the wording “-based” and is related to wax or a complex which will be described later.

In one example, the binder resin may include the polyester-based resin. One reason for this is that it is easier to cause a surface of the brilliant image to be smoother, which makes it more difficult for the brilliant characteristics to be decreased and also makes it more difficult for the brilliant characteristics to have variation.

The polyester-based resin may be a reactant, i.e., a condensation polymer, of alcohol and carboxylic acid. The alcohol may include only one type of alcohol or may include two or more types of alcohol. Similarly, the carboxylic acid may include only one type of carboxylic acid or may include two or more types of carboxylic acid.

The type of the alcohol is not particularly limited. In one example, the alcohol may be an alcohol having a valence of two or greater or a derivative thereof. Non-limiting examples of the alcohol having the valence of two or greater may include ethylene glycol, diethylene glycol, triethylene glycol, polyethylene glycol, propylene glycol, butanediol, pentanediol, hexanediol, cyclohexanedimethanol, xylene glycol, dipropylene glycol, polypropylene glycol, bisphenol A, hydrogenated bisphenol A, bisphenol A ethylene oxide, bisphenol A propylene oxide, sorbitol, and glycerin.

The type of the carboxylic acid is not particularly limited. In one example, the carboxylic acid may be carboxylic acid having a valence of two or greater or a derivative thereof. Non-limiting examples of the carboxylic acid having the valence of two or greater may include maleic acid, fumaric acid, phthalic acid, isophthalic acid, terephthalic acid, succinic acid, adipic acid, trimellitic acid, pyromellitic acid, cyclopentane dicarboxylic acid, succinic anhydride, trimellitic anhydride, maleic anhydride, and dodecenylsuccinic anhydride.

### [Other Materials]

It is to be noted that the brilliant toner may further include one or more of other materials. The type of the other materials is not particularly limited. Non-limiting examples of the other materials may include a colorant, a release agent, an electric charge control agent, and an external additive.

### [Colorant]

A colorant may so adjust the color of the brilliant toner that the brilliant toner has a desired color. The type, e.g., the color, of the colorant is not particularly limited. Therefore, the type, e.g., the color, of the colorant may be determined in accordance with the color of the brilliant toner.

For example, the colorant may include one or more of a yellow colorant, a magenta colorant, a cyan colorant, a black colorant, and a colorant of any other color.

The yellow colorant may include one or more of a yellow pigment, etc., for example. Non-limiting examples of the yellow pigment may include Pigment Yellow 74.

The magenta colorant may include one or more of a magenta pigment, etc., for example. Non-limiting examples of the magenta pigment may include quinacridone.

The cyan colorant may include one or more of a cyan pigment, etc., for example. Non-limiting examples of the cyan pigment may include phthalocyanine blue.

The black colorant may include one or more of a black pigment, etc., for example. Non-limiting examples of the black pigment may include carbon black. Non-limiting examples of the carbon black may include furnace black and channel black.

Whether or not the brilliant toner includes the colorant may be decided in accordance with the color of the brilliant toner. For example, on a condition that the brilliant toner includes aluminum as the brilliant pigment and the color of the brilliant toner is silver, the brilliant toner may not include any colorant. One reason for this is that the color of the brilliant toner becomes silver by utilizing the color of the brilliant pigment itself although the brilliant toner does not include any colorant.

Further, a factor such as the color of the colorant included in the brilliant toner or a combination of the colors of the colorants included in the brilliant toner may be decided in accordance with the color of the brilliant toner. For example, on a condition that the brilliant toner includes aluminum as the brilliant pigment and the color of the brilliant toner is gold, the brilliant toner may include the yellow colorant and the magenta colorant. One reason for this is that the brilliant toner includes the colorants, i.e., the yellow colorant and the magenta colorant, together with the brilliant pigment, and therefore, the color of the brilliant toner becomes gold by utilizing the color of the brilliant pigment and the colors of the colorants.

### [Release Agent]

The release agent may improve characteristics, of the brilliant toner, such as fixing characteristics or offset resistance. The release agent may include one or more of waxes such as aliphatic-hydrocarbon-based wax, an oxide of aliphatic-hydrocarbon-based wax, fatty-acid-ester-based wax, or a deoxide of fatty-acid-ester-based wax. Other than the waxes described above, the release agent may also be a block copolymer of any two or more of the series of waxes described above, for example.

Non-limiting examples of the aliphatic-hydrocarbon-based wax may include low-molecular polyethylene, low-molecular polypropylene, a copolymer of olefin, microcrystalline wax, paraffin wax, and Fischer-Tropsch wax. Non-limiting examples of the oxide of aliphatic-hydrocarbon-based wax may include oxidized polyethylene wax. Non-limitino examples of the fatty-acid-ester-based wax may include carnauba wax and montanic acid ester wax. The deoxide of fatty-acid-ester-based wax may be partially-deoxidized or fully-deoxidized fatty-acid-ester-based wax. Non-limiting examples of the deoxide of fatty-acid-ester-based wax may include deoxidized carnauba wax.

### [Electric Charge Control Agent]

The electric charge control agent may control characteristics such as triboelectric charging characteristics of the brilliant toner. The electric charge control agent to be used for the negatively-charged brilliant toner may include one or more of materials such as an azo-based complex, a salicylic-acid-based complex, or a calixarene-based complex, for example.

### [External Additive]

The external additive may suppress a phenomenon such as aggregation in the brilliant toner, and thereby improve fluidity of the brilliant toner. Non-limiting examples of the external additive may include a plurality of hydrophobic particles. The external additive may include only one type of external additive, or may include two or more types of external additives.

The external additive may include, for example, one or more of materials such as an inorganic material or an organic material. Non-limiting examples of the inorganic material may include hydrophobic silica. Non-limiting examples of the organic material may include polymethyl methacrylate (PMMA).

### [1-2 Physical Property]

A description is given below of a physical property of the brilliant toner.

When a brilliant image is to be formed on a print medium by means of an image forming apparatus which will be described later with reference to FIG. 2, a weight-average molecular weight of the brilliant toner may be made appropriate, thereby allowing formation of a higher-quality brilliant image with stability. In one example, the weight-average molecular weight of the brilliant toner may be equal to or greater than about 19601 and equal to or smaller than about 55938. In another example, the weight-average molecular weight of the brilliant toner may be equal to or greater than about 30436 and equal to or smaller than about 55938.

In detail, in a case where the weight-average molecular weight of the brilliant toner is equal to or greater than about 19601, compared with a case Where the weight-average molecular weight of the brilliant toner is smaller than about 19601, it is more difficult for an interface between the brilliant pigment and the binder resin to break in the brilliant toner. Therefore, the print medium may be conveyed with stability at time of forming the brilliant image.

For example, it is more difficult for the interface between the brilliant pigment and the binder resin to break at time of forming the brilliant image with the use of the brilliant toner. Accordingly, it is more difficult for the brilliant toner to be attached around a component such as a heating roller 51 in a fixing process which will be described later. This allows the print medium to be conveyed with stability while the fixing process using the brilliant toner is performed.

For example, in a case where the brilliant pigment includes the plurality of flat particles as illustrated in FIG. 1, the flat particles of the brilliant pigment may be so stacked that the respective surfaces N are adjacent to each other, thereby forming a stack. In this case, it more difficult for the brilliant toner to be attached around the component such as the heating roller 51 in the fixing process, even when thermal attaching force between the surfaces N increases. One reason for this is that the stack is less separable in the vicinity of the interfaces between the surfaces N in this case.

For example, in a case where the weight-average molecular weight of the brilliant toner is equal to or greater than about 30436, it is more difficult for the interface between the brilliant pigment and the binder resin to break. This allows the print medium to be conveyed with higher stability at the time of forming the brilliant image.

In contrast, in a case where the weight-average molecular weight of the brilliant toner is equal to or smaller than about 55938, compared with a case where the weight-average molecular weight of the brilliant toner is greater than about 55938, it is easier for a surface of the brilliant image to be smoother. This ensures glossiness, of the brilliant image, which greatly influences the quality of the brilliant image.

Accordingly, in the case where the weight-average molecular weight of the brilliant toner is equal to or greater than about 19601 and equal to or smaller than about 55938, the print medium is conveyed with stability at the time of forming the brilliant image. This allows formation of the brilliant image with stability and improvement of glossiness of the brilliant image. Therefore, the quality of the brilliant image is improved. Hence, the higher-quality brilliant image is formed with stability.

The “weight-average molecular weight” of the brilliant toner may be measured by analyzing the brilliant toner by gel permeation chromatography (GPC). Details of a method of measuring the weight-average molecular weight may be the following, for example.

When an analysis sample is to be obtained, the brilliant toner and an organic solvent may be mixed with each other. Non-limiting examples of the organic solvent may include tetrahydrofuran. Thereafter, the mixture may be stirred, and a soluble component such as the binder resin may be thereby dissolved in the organic solvent. This allows for separation, in the organic solvent, of the soluble component such as the binder resin and an insoluble component such as the brilliant pigment from each other. Therefore, a filtered material of the solution including the soluble component and the insoluble component may be used as the sample. The above-described filtered material may be, for example, a filtered solution including the soluble component.

When the sample is to be analyzed, a GPC system CBD-20D available from Shimadzu Corporation, located in Kyoto, Japan, may be used as an analysis apparatus. Further, two TSKgel GMHX and one TSKgel G2500HXL both available from Tosoh Corporation, located in Yamaguchi, Japan, may be used as columns.

As analysis conditions, a concentration of the sample may be set to about 0.2 mass %, a flow velocity may be set to about 1.0 ml/min (=about 1.0 cm³/min), an injection amount of the sample may be set to about 200 μl (=about 0.2 cm³), a measuring temperature may be set to about 40° C., and a refractive index detector (RI) may be used as a detector. A calibration curve may be made with the use of analysis columns Shodex STANDARD including twelve samples having molecular weights of 3730000, 1470000, 678000, 257000, 112000, 46500, 19800, 6930, 2900, 1930, 1200, and 580, available from Showa Denko K. K., located in Tokyo, Japan.

### [1-3. Manufacturing Method]

A description is given below of an example of a method of manufacturing the brilliant toner.

The method of manufacturing the brilliant toner is not particularly limited. For example, a case of manufacturing the brilliant toner by a solution suspension method is described below. In a case where the solution suspension method is used as the method of manufacturing the brilliant toner, for example, it is easier to control a particle size of the brilliant toner, which allows for easier manufacturing of the brilliant toner with a desired particle size.

### [Preparation of Oil Phase]

When the brilliant toner is to be manufactured by the solution suspension method, an oil phase may be prepared first. In this case, first, an organic solvent may be prepared.

The organic solvent may include, for example, one or more of materials such as ester, hydrocarbon, halogenated hydrocarbon, alcohol, or ketone. Non-limiting examples of the ester may include methyl acetate, ethyl acetate, and butyl acetate. Non-limiting examples of the hydrocarbon may include toluene and xylene. Non-limiting examples of the halogenated hydrocarbon may include methylene chloride, chloroform, and dichloroethane. Non-limiting examples of the alcohol may include methanol or ethanol. Non-limiting examples of the ketone may include acetone, methyl ethyl ketone, and cyclohexanone. Details related to the organic solvent described above may be similarly applicable to the organic solvent which will be described hereinafter.

It is to be noted that a polymer-based dispersant may be added to the organic solvent, and thereafter, the organic solvent with the dispersant may be stirred. In this case, the polymer-based dispersant may be dissolved by the organic solvent.

The polymer-based dispersant may include, for example, one or more of polymer compounds having a basic functional group. The polymer-based dispersant is not particularly limited in its type.

Thereafter, the brilliant pigment may be added to the organic solvent. Thereafter, the organic solvent with the brilliant pigment may be stirred. The brilliant pigment may be thereby dispersed in the organic solvent. As a result, a brilliant dispersion liquid may be obtained. The brilliant pigment added to the organic solvent may include only one type of brilliant pigment, or may include two or more types of brilliant pigments, as described above.

Thereafter, the binder resin may be added to the brilliant dispersion liquid. Thereafter, the brilliant dispersion liquid with the binder resin may be stirred. The binder resin may be thereby dispersed by the brilliant dispersion liquid. As a result, a brilliant solution may be obtained. In this case, in one example, the brilliant dispersion liquid may be heated. Further, the colorant may be added to the brilliant dispersion liquid together with the binder resin, and thereby be dispersed in the brilliant dispersion liquid as described above, in one example.

Thereafter, materials such as the organic solvent, the release agent, or the electric charge control agent may be added to the brilliant solution. Thereafter, the brilliant solution with the materials such as the organic solvent, the release agent, or the electric charge control agent may be stirred. As a result, an oil phase including materials such as the brilliant pigment, the binder resin, the release agent, or the electric charge control agent may be obtained. In this case, the organic solvent may be possibly heated in advance in one example.

It is to be noted that, although the addition of the material such as the release agent is performed after the addition of the binder resin to the brilliant pigment in the above-described example, timing to mix the brilliant pigment, the binder resin, and the material such as the release agent is not particularly limited. For example, the brilliant pigment, the binder resin, and the material such as the release agent may be mixed with each other at the same timing.

### [Preparation of Aqueous Phase]

Thereafter, a material such as an inorganic dispersant, e.g., a suspension stabilizer, may be added to an aqueous medium. Thereafter, the aqueous medium with the material such as the inorganic dispersant may be stirred. The inorganic dispersant may be thereby dispersed or dissolved by the aqueous medium. As a result, an aqueous phase may be obtained.

The aqueous medium may include, for example, one or more of materials such as pure water. The aqueous medium may be, for example, a mixture of pure water and a soluble solvent.

The inorganic dispersant may include, for example but not limited to, one or more of inorganic materials such as trisodium phosphate, tricalcium phosphate, hydroxyapatite, calcium carbonate, calcium chloride, titanium oxide, aluminum hydroxide, magnesium hydroxide, barium sulfate, or silica. Non-limiting examples of the silica may include silicon dioxide.

### [Granulation]

Thereafter, granulation may be performed with the use of the oil phase and the aqueous phase described above. In this case, first, the oil phase may be added to the aqueous phase. Thereafter, the aqueous phase with the oil phase may be stirred. A mixture ratio between the aqueous phase and the oil phase is not particularly limited, and therefore may be set to any ratio. The mixture of the oil phase and the aqueous phase may be thereby suspended and subjected to granulation. As a result, slurry including a plurality of toner base particles may be obtained. The obtained toner base particles may be precursor particles directed to manufacturing of the brilliant toner.

Thereafter, the slurry may be distilled under a reduced pressure. The organic solvent included in the slurry may be thereby volatilized and removed. Thereafter, a pH regulator may be added to the slurry. Thereafter, the slurry with the pH regulator may be stirred. The inorganic dispersant may be thereby dissolved and removed. The pH regulator may include, for example, one or more of acid such as nitric acid. Thereafter, the slurry may be dehydrated. The toner base particles may be thereby collected from the slurry. Thereafter, the collected toner base particles may be washed. In this case, for example, the toner base particles may he re-dispersed in pure water, and the pure water with the toner base particles may be stirred thereafter.

Thereafter, the toner base particles may be dehydrated and dried. Thereafter, the toner base particles dehydrated and dried may be classified.

### [External Addition Process]

Thereafter, the external additive may be added to the toner base particles. Thereafter, the mixture may be stirred. The external additive may include, for example, one or more of hydrophobic particles, as described above. A mixture ratio between the toner base particles and the external additive is not particularly limited. The external additive may be thereby fixed to surfaces of the respective toner base particles.

The external additive may be thereby externally added to the toner base particles. As a result, the brilliant toner may be completed.

### [1-4. Example Workings and Example Effects]

A description is given below of example workings and example effects of the brilliant toner.

The brilliant toner includes the brilliant pigment and the binder resin. Further, the brilliant toner has a weight-average molecular weight that is equal to or greater than about 19601 and equal to or smaller than about 55938. In this case, as described above, the print medium is conveyed with stability at the time of forming the brilliant image by means of the image forming apparatus. Therefore, the brilliant image is formed with stability and the glossiness of the brilliant image is improved. This improves the quality of the formed brilliant image. Hence, it is possible to form higher-quality brilliant image with stability.

In one example where the brilliant pigment includes the plurality of flat particles, superior brilliant characteristics are allowed to be obtained. Hence, it is possible to obtain higher effects. In one example, of this case, where: the average thickness TA of the flat particles of the brilliant pigment is equal to or greater than about 0.1 μm and equal to or smaller than about 1 μm; the average length L1A of the major axes X of the respective flat particles of the brilliant pigment is equal to or greater than about 5 μm and equal to or smaller than about 20 μm; and the average length L2A of the minor axes Y of the respective flat particles of the brilliant pigment is equal to or greater than about 2 μm and equal to or smaller than about 12 μm, sufficient brilliant characteristics are allowed to be obtainede. Hence, it is possible to obtain further higher effects.

Moreover, in a case where the content of the brilliant pigment is equal to or greater than about 10 wt % and equal to or smaller than about 30 wt %, the brilliant characteristics and the electric charge characteristics are also improved in addition to the conveyance characteristics of the print medium and glossiness described above. Hence, it is possible to obtain further higher effects.

Moreover, in a case where the binder resin includes the polyester-based resin, it is easier for the surface of the brilliant image to be smoother. This further improves the quality of the brilliant image. Hence, it is possible to obtain further higher effects.

### 2. IMAGE FORMING APPARATUS (TONER CONTAINER AND DEVELOPING UNIT)

A description is given below of an image forming apparatus according to an example embodiment of the technology, in which the brilliant toner described above is used.

A toner container according to an example embodiment of the technology and a developing unit according to an example embodiment of the technology may constitute part of the image forming apparatus described below. Accordingly, a description is also given below of the toner container and the developing unit together with the image forming apparatus.

For example, the image forming apparatus may form a brilliant image on a print medium M with the use of the brilliant toner. The print medium M will be described later with reference to FIG. 2. The image forming apparatus may be, for example, a full-color printer using a so-called electrophotographic method.

For example, the image forming apparatus described below may be of an intermediate transfer method that forms the brilliant image on the print medium M, for example, with the use of an intermediate transfer belt 41 which will be described later.

The image forming apparatus may be mounted with, for example, a non-brilliant toner together with the brilliant toner. The non-brilliant toner will be described later. The non-brilliant toner may have no brilliant characteristics. In other words, the non-brilliant toner may be colored toner that is typically used in an electrophotographic image forming apparatus to form a full-color image. The non-brilliant toner is not particularly limited in its type; however, the non-brilliant toner may include, for example, a yellow toner, a magenta toner, a cyan toner, and a black toner.

The image forming apparatus may thus be able to form the brilliant image with the use of the brilliant toner and also to form a non-brilliant image, e.g., a usual color image, with the use of the non-brilliant toner, for example. It goes without saying that the image forming apparatus may form the brilliant image with the use of both the brilliant toner and the non-brilliant toner, for example.

Hereinafter, the brilliant toner, the yellow toner, the magenta toner, the cyan toner, and the black toner are referred to by the respective corresponding terms independently from each other. However, some of the above-described toners are collectively referred to by a collective term on an as-needed basis. For example, the yellow toner, the magenta toner, the cyan toner, and the black toner are collectively referred to as the “non-brilliant toner”. Further, the brilliant toner, the yellow toner, the magenta toner, the cyan toner, and the black toner are collectively referred to as the “toner”.

Further, hereinafter, the brilliant image and the non-brilliant image are referred to by the respective corresponding terms independently from each other. However, the brilliant image and the non-brilliant image may be also collectively referred to as an “image”.

It is to be noted that the print medium M is not particularly limited in its type; however, the print medium M may include one or more of materials such as paper or a film.

### [2-1. General Configuration]

A description is given first of an example of a general configuration of the image forming apparatus.

FIG. 2 illustrates an example of a planar configuration of the image forming apparatus. The image forming apparatus may involve conveyance of the print medium M along respective conveyance routes R1 to R5 in the process of forming an image. Each of the conveyance routes R1 to R5 is illustrated by a dashed line in FIG. 2.

Referring to FIG. 2, the image forming apparatus may include, inside a housing 1, a tray 10, a feeding roller 20, a developing unit 30, a transfer section 40, a fixing section 50, conveying rollers 61 to 68, and conveyance path switching guides 69 and 70, for example.

The image forming apparatus may be able to form an image on one side of the print medium M and also able to form images on both sides of the print medium M, for example.

In the description below, in a case where the image forming apparatus forms an image only on one side of the print medium M, the surface on which the image is to be formed is referred to as a “front surface” of the print medium M. Further, in a case where the image forming apparatus forms images on both sides of the print medium M, a surface on which one of the images is to be formed is referred to as a “front surface” of the print medium M, and a surface on which the other of the images is to be formed, i.e., a surface opposite to the front surface, is referred to as a “back surface” of the print medium M.

That is, in the case where an image is formed only on one side of the print medium M, the image is formed on the front surface of the print medium M. In contrast, in the case where images are formed on both sides of the print medium M, the image is formed on each of the front surface and the back surface of the print medium M.

### [Housing]

The housing 1 may include, for example, one or more of materials such as a metal material or a polymer compound. The housing 1 may be provided, for example, with a stacker 2. The print medium M on which the image is formed by the image forming apparatus may be discharged from a discharge opening 1H provided in the housing 1 to the stacker 2. [Tray and Feeding Roller]

The tray 10 may contain the print medium M. The tray 10 may be attached detachably to the housing 1, for example. The feeding roller 20 may be, for example, a cylindrical member that extends in a Y-axis direction and is rotatable around the Y-axis.

Each of components referred to by a name including the term “roller” out of components of the image forming apparatus which will be described later may be a cylindrical member that extends in the Y-axis direction and is rotatable around the Y-axis, as with the feeding roller 20 described above.

The tray 10 may contain a plurality of print media M in a stacked state, for example. The print media M contained in the tray 10 may be picked out one by one from the tray 10 by the feeding roller 20, for example.

The number of the provided tray 10 is not particularly limited, and may be only one or two or more. Similarly, the number of the provided feeding roller 20 is not particularly limited, and may be only one or two or more. FIG. 2 illustrates an example case in which one tray 10 and one feeding roller 20 are provided. [Developing Unit]

The developing unit 30 may perform a developing process, i.e., a process of attaching the toner to an electrostatic latent image. For example, the developing unit 30 may form the electrostatic latent image, and attach the toner to the electrostatic latent image by utilizing Coulomb force.

In this example, the image forming apparatus may include five developing units 30, i.e., developing units 30S, 30Y, 30M, 30C, and 30K. The developing units 30S, 30Y, 30M, 30C, and 30K each may be attached detachably to the housing 1, and may be arranged along a traveling path of an intermediate transfer belt 41 which will be described later, for example. In this example, the developing units 30S, 30Y, 30M, 30C, and 30K may be disposed in this order from upstream toward downstream in a traveling direction, illustrated by an arrow F5, in which the intermediate transfer belt 41 travels.

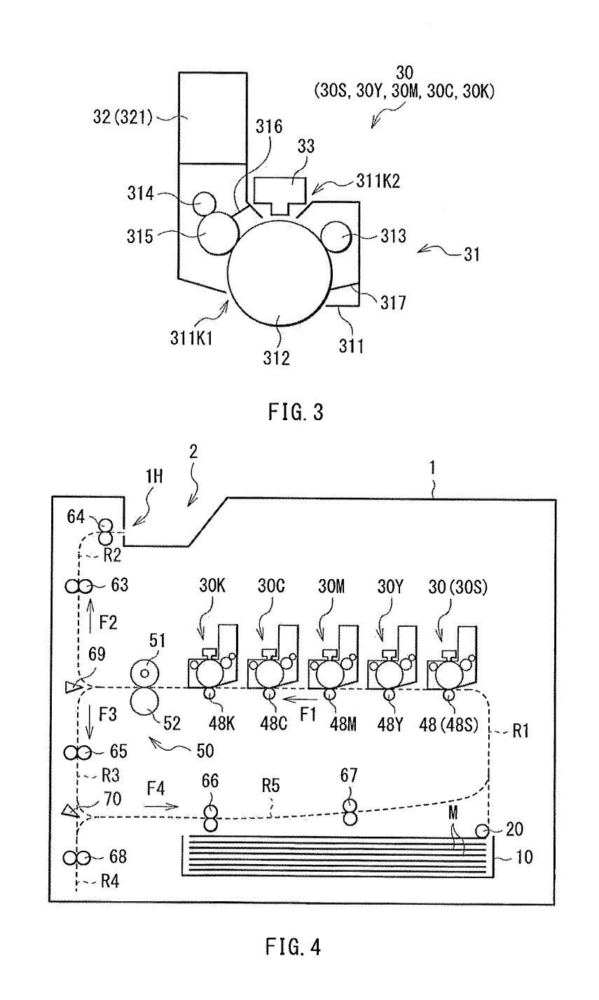

The developing units 30S, 30Y, 30M, 30C, and 30K may have configurations similar to each other, except for having toners different in type from each other, for example. The toners may each be contained in a toner cartridge 32 which will be described later with reference to FIG. 3.

As described above, five types of toners, i.e., the brilliant toner and the non-brilliant toners including the yellow toner, the magenta toner, the cyan toner, and the black toner may be used in the example described below.

For example, the developing unit 30S may contain the brilliant toner. The developing unit 30Y may contain the yellow toner that is the non-brilliant toner, for example. The developing unit 30M may contain the magenta toner that is the non-brilliant toner, for example. The developing unit 30C may contain the cyan toner that is the non-brilliant toner, for example. The developing unit 30K may contain the black toner that is the non-brilliant toner, for example.

A detailed configuration of each of the developing units 30S, 30Y, 30M, 30C, and 30K will be described later with reference to FIG. 3. Configurations of the respective non-brilliant toners including the yellow toner, the magenta toner, the cyan toner, and the black toner will be also described later.

### [Transfer Section]

The transfer section 40 may perform a transfer process of the toner that has been subjected to the developing process by the developing unit 30. For example, the transfer section 40 may transfer, onto the print medium M, the toner that has been attached to the electrostatic latent image by the developing unit 30.

The transfer section 40 may include the intermediate transfer belt 41, a driving roller 42, a driven roller 43, a backup roller 44, a primary transfer roller 45, a secondary transfer roller 46, and a cleaning blade 47, for example.

The intermediate transfer belt 41 may be an intermediate transfer medium onto which the toner is temporarily transferred before the toner is transferred onto the print medium M. The intermediate transfer belt 41 may be an elastic endless belt, for example. The intermediate transfer belt 41 may include one or more of polymer compounds such as polyimide, for example. The intermediate transfer belt 41 may be able to travel in the direction indicated by the arrow F5 in response to rotation of the driving roller 42, while lying on the driving roller 42, the driven roller 43, and the backup roller 44 in a stretched state, for example.

The driving roller 42 may be rotatable, for example, by utilizing power of a device such as a motor. Each of the driven roller 43 and the backup roller 44 may be rotatable in accordance with the rotation of the driving roller 42, for example.

The primary transfer roller 45 may transfer, onto the intermediate transfer belt 41, the toner attached to the electrostatic latent image. In other words, the primary transfer roller 45 may perform primary transfer. The primary transfer roller 45 may be so pressed against a photosensitive drum 312 as to be in contact with the photosensitive drum 312 with the intermediate transfer belt 41 in between. The photosensitive drum 312 will be described later with reference to FIG. 3. It is to be noted that the primary transfer roller 45 may be rotatable by utilizing revolution force derived from a device such as a motor, for example.

The number of the provided primary transfer roller 45 is not particularly limited. Therefore, only one primary transfer roller 45 may be provided, or two or more primary transfer rollers 45 may be provided. In this example, the image forming apparatus may include five primary transfer rollers 45, i.e., primary transfer rollers 45S, 45Y, 45M, 45C, and 45K, corresponding to the five developing units 30, i.e., the developing units 30S, 30Y, 30M, 30C, and 30K, described above. The image forming apparatus may also include one secondary transfer roller 46 corresponding to the one backup roller 44.

The secondary transfer roller 46 may transfer, onto the print medium M, the toner that has been transferred onto the intermediate transfer belt 41. In other words, the secondary transfer roller 46 may perform secondary transfer. The secondary transfer roller 46 may be so pressed against the backup roller 44 as to be in contact with the backup roller 44. The secondary transfer roller 46 may include a metal core and an elastic layer, for example. The elastic layer may cover an outer peripheral surface of the metal core, for example. Non-limiting example of the elastic layer may be a foamed rubber layer. It is to be noted that the secondary transfer roller 46 may be rotatable by utilizing power derived from a device such as a motor, for example.

The cleaning blade 47 may be so pressed against the intermediate transfer belt 41 as to be in contact with the intermediate transfer belt 41. The cleaning blade 47 may scrape off an extraneous material such as unnecessary remains of the toner on the surface of the intermediate transfer belt 41.

### [Fixing Section]

The fixing section 50 may perform a fixing process of the toner that has been transferred onto the print medium M by the transfer section 40. For example, the fixing section 50 may apply a pressure onto the print medium M onto which the toner has been transferred by the transfer section 40, while heating the print medium M. The fixing section 50 may thereby fix the toner to the print medium M.

The fixing section 50 may include a heating roller 51 and a pressure applying roller 52, for example.

The heating roller 51 may heat the toner transferred onto the print medium M. The heating roller 51 may include a metal core and a resin coating, for example. The resin coating may cover a surface of the metal core, for example. The resin coating may include one or more of polymer compounds such as a copolymer of tetrafluoroethylene and perfluoroalkylvinylether (PFA), or polytetrafluoroethylene (PTFE), for example.

A heating source such as a heater may be disposed inside the heating roller 51, for example. The heater may be disposed inside the metal core of the heating roller 51, for example. A temperature measuring device such as a thermistor may be so disposed in the vicinity of the heating roller 51 that the heating roller 51 and the temperature measuring device such as the thermistor may be spaced apart from each other, for example. The thermistor may measure a surface temperature of the heating roller 51, for example.

The pressure applying roller 52 may be so pressed against the heating roller 51 as to be in contact with the heating roller 51. The pressure applying roller 52 may apply a pressure onto the toner transferred onto the print medium M. The pressure applying roller 52 may include a metal core and a heat-resistant elastic layer, for example. The heat-resistant elastic layer may cover a surface of the metal core, for example. The heat-resistant elastic layer may include one or more of rubber materials such as silicone rubber, for example.

### [Conveying Roller]

Each of the conveying rollers 61 to 68 may include a pair of rollers that face each other with corresponding one of the conveyance routes R1 to R5 in between. Each of the conveying rollers 61 to 68 may convey the print medium M that has been taken out by the feeding roller 20.

In the case where the image is to be formed only on one side of the print medium M, i.e., only on the front surface of the print medium M, the print medium M may be conveyed by the conveying rollers 61 to 64 along the conveyance routes R1 and R2, for example. In the case where the images are to be formed on both sides of the print medium M, i.e., on both the front surface and the back surface of the print medium M, the print medium M may be conveyed by the conveying rollers 61 to 68 along the conveyance routes R1 to R5, for example.

### [Conveyance Path Switching Guide]

The conveyance path switching guides 69 and 70 each may switch a conveyance direction, of the print medium M, in which the print medium M is to be conveyed, depending on a form of the image to be formed on the print medium M. Non-limiting examples of the form of the image to be formed on the print medium M may include a one-side image formation mode, i.e., a form in which the image is to be formed only on one side of the print medium M, and a both-side image forming mode, i.e., a form in which the images are to be formed on both sides of the print medium M.

### [2-2. Configuration of Developing Unit]

A description is given below of a configuration of the developing unit 30. FIG. 3 illustrates, in an enlarged fashion, an example of a planar configuration of the developing unit 30, i.e., each of the developing units 30S, 30Y, 30M, 30C, and 30K, illustrated in FIG. 2.

As described above, the developing units 30S, 30Y, 30M, 30C, and 30K may have configurations similar to each other, except for having toners different in type from each other, for example. The toners of the developing units 30S, 30Y, 30M, 30C, and 30K may each be contained in the toner cartridge 32, for example.

For example, referring to FIG. 3, the developing units 30S, 30Y, 30M, 30C, and 30K each may include a developing process unit 31 and the toner cartridge 32, for example. The developing process unit 31 may be provided with a light source 33, for example. The toner cartridge 32 may correspond to a “toner container” in one specific but non-limiting embodiment of the technology.

### [Developing Process Unit]

The developing process unit 31 may perform the developing process with the use of the toner contained in the toner cartridge 32. The developing process unit 31 may include inside a housing 311, for example, the photosensitive drum 312, a charging roller 313, a feeding roller 314, a developing roller 315, a developing blade 316, and a cleaning blade 317. It is to be noted that the toner cartridge 32 may be attached detachably to the housing 311, for example. The light source 33 may be disposed outside of the housing 311, for example.

The developing units 30S, 30Y, 30M, 30C, and 30K may each be movable between a standby position and a contact position, for example. When each of the developing units 30S, 30Y, 30M., 30C, and 30K is located at the standby position, the photosensitive drum 312 may be recessed away from the intermediate transfer belt 41. Therefore, the photosensitive drum 312 may not be so pressed against the primary transfer roller 45 as to be in contact with the primary transfer roller 45 with the intermediate transfer belt 41 in between. In contrast, when each of the developing units 30S, 30Y, 30M, 30C, and 30K is located at the contact position, the photosensitive drum 312 may be advanced toward the intermediate transfer belt 41. Therefore, the photosensitive drum 312 may be pressed against the primary transfer roller 45 while being applied with a pressure with the intermediate transfer belt 41 in between.

### [Housing]

The housing 311 may include one or more of materials such as a metal material and a polymer compound, for example. The housing 311 may have an opening 311K1 from which the photosensitive drum 312 is partially exposed, for example. The housing 311 may also have an opening 311K2 that guides, to the photosensitive drum 312, light outputted from the light source 33.

### [Photosensitive Drum]

The photosensitive drum 312 may be a latent image supporting member on which the electrostatic latent image is formed and that supports the electrostatic latent image. The photosensitive drum 312 may extend in the Y-axis direction, and be rotatable around the Y-axis. The photosensitive drum 312 may be an organic photoreceptor that includes a cylindrical electrically-conductive supporting body and a photoconductive layer, for example. The photoconductive layer may cover an outer peripheral surface of the electrically-conductive supporting body. The photosensitive drum 312 may be rotatable by utilizing power derived from a device such as a motor.

### [Charging Roller]

The charging roller 313 may be so pressed against the photosensitive drum 312 as to be in contact with the photosensitive drum 312. The charging roller 313 may electrically charge a surface of the photosensitive drum 312. The charging roller 313 may include a metal shaft and an electrically-semiconductive epichlorohydrin rubber layer that covers an outer peripheral surface of the metal shaft, for example.

### [Feeding Roller]

The feeding roller 314 may be so pressed against the developing roller 315 as to be in contact with the developing roller 315. The feeding roller 314 may feed the toner to a surface of the developing roller 315. The feeding roller 314 may include a metal shaft and an electrically-semiconductive foamed silicon sponge layer that covers an outer peripheral surface of the metal shaft, for example. The feeding roller 314 may he a so-called sponge roller, for example.

### [Developing Roller]

The developing roller 315 may be so pressed against the photosensitive drum 312 as to be in contact with the photosensitive drum 312. The developing roller 315 may support the toner that is fed from the feeding roller 314, and attach the fed toner onto the electrostatic latent image formed on the surface of the photosensitive drum 312. The developing roller 315 may include a metal shaft and an electrically-semiconductive urethane rubber layer that covers an outer peripheral surface of the metal shaft, for example.

### [Developing Blade]

The developing blade 316 may be a plate-like member that controls the thickness of the toner fed to the surface of the developing roller 315. The developing blade 316 may be disposed at a position away from the developing roller 315 with a predetermined distance, i.e., predetermined spacing, in between, for example. The thickness of the toner may be controlled on the basis of the distance, i.e., the spacing, between the developing roller 315 and the developing blade 316. The developing blade 316 may include one or more of metal materials such as stainless steel, for example.

### [Cleaning Blade]

The cleaning blade 317 may be a plate-like elastic member that scrapes off an extraneous material such as unnecessary remains of the toner that are present on the surface of the photosensitive drum 312. The cleaning blade 317 may extend in a direction substantially parallel to a direction in which the photosensitive drum 312 extends, for example. The cleaning blade 317 may be so pressed against the photosensitive drum 312 as to be in contact with the photosensitive drum 312. The cleaning blade 317 may include one or more of polymer compounds such as urethane rubber, for example.

### [Toner Cartridge]

The toner cartridge 32 may contain the toner. The toner cartridge 32 may include a toner containing receptacle 321 that contains the toner. The toner contained in the toner containing receptacle 321 may be fed to the developing process unit 31 on an as-needed basis. The toner containing receptacle 321 may correspond to a “toner containing unit” in one specific but non-limiting embodiment of the technology.

The yellow toner contained in the toner cartridge 32 of the developing unit 30Y may have, for example, a configuration similar to that of the brilliant toner except that the yellow toner includes the yellow pigment instead of the brilliant pigment. The magenta toner contained in the toner cartridge 32 of the developing unit 30M may have, for example, a configuration similar to that of the brilliant toner except that the magenta toner includes the magenta pigment instead of the brilliant pigment. The cyan toner contained in the toner cartridge 32 of the developing unit 30C may have, for example, a configuration similar to that of the brilliant toner except that the cyan toner includes the cyan pigment instead of the brilliant pigment. The black toner contained in the toner cartridge 32 of the developing unit 30K may have, for example, a configuration similar to that of the brilliant toner except that the black toner includes the black pigment instead of the brilliant pigment. It is to be noted that details related to each of the yellow pigment, the magenta pigment, the cyan pigment, and the black pigment may be as described above, for example.

### [Light Source]

The light source 33 may be an exposure device that performs exposure on the surface of the photosensitive drum 312 to thereby form the electrostatic latent image on the surface of the photosensitive drum 312. The light source 33 may be, for example, a light-emitting diode (LED) head including components such as an LED element or a lens array. The LED element and the lens array may be so disposed that the light outputted from the LED element forms an image on the surface of the photosensitive drum 312, for example.

### [2-3. Operation]

A description is given below of an example operation of the image forming apparatus.

When an image is to be formed on the print medium M, the image forming apparatus may perform a developing process, a primary transfer process, a secondary transfer process, and a fixing process in this order as will be described below, for example. Further, when the image is to be formed on the print medium M, the image forming apparatus may also perform a cleaning process on an as-needed basis.

### [Formation of Brilliant Image]

A description is given below of an example case of forming a brilliant image on the print medium M with the use of the brilliant toner contained in the developing unit 30S.

### [Developing Process]

In the case of forming the brilliant image on the print medium M, first, the print medium M contained in the tray 10 may be picked up by the feeding roller 20. The print medium M picked up by the feeding roller 20 may be conveyed by the conveying rollers 61 and 62 along the conveyance route R1 in a direction indicated by an arrow F1.

The developing process may involve the operation performed in the developing process unit 31 of the developing unit 30S as described below. In the developing process unit 31 of the developing unit 30S, the charging roller 313 may apply a direct-current voltage to the surface of the photosensitive drum 312 while rotating in accordance with the rotation of the photosensitive drum 312. The surface of the photosensitive drum 312 may be thereby electrically charged evenly.

Thereafter, the light source 33 may apply light to the surface of the photosensitive drum 312 on the basis of image data. A surface potential in a region, of the surface of the photosensitive drum 312, on which the light is applied is thereby attenuated. In other words, optical attenuation occurs. An electrostatic latent image may be thus formed on the surface of the photosensitive drum 312. It is to be noted that the image data described above may be supplied to the image forming apparatus from an external apparatus such as a personal computer, for example.

In the developing unit 30S, the brilliant toner contained in the toner cartridge 32 may be discharged toward the feeding roller 314.

The feeding roller 314 may rotate when receiving application of a voltage. The brilliant toner may be thereby fed from the toner cartridge 32 to the surface of the feeding roller 314.

The developing roller 315 may rotate while being so pressed against the feeding roller 314 as to be in contact with the feeding roller 314, when receiving application of a voltage. The brilliant toner fed to the surface of the feeding roller 314 may be thereby attached to the surface of the developing roller 315, whereby the brilliant toner may be conveyed by utilizing the rotation of the developing roller 315. In this case, the brilliant toner attached to the surface of the developing roller 315 may be partially removed by the developing blade 316, whereby the brilliant toner attached to the surface of the developing roller 315 may be caused to have an even thickness.

After the photosensitive drum 312 rotates while being so pressed against the developing roller 315 as to be in contact with the developing roller 315, the brilliant toner attached to the surface of the developing roller 315 may be moved onto the surface of the photosensitive drum 312. The brilliant toner may be thereby attached to the surface of the photosensitive drum 312, i.e., to the electrostatic latent image.

### [Primary Transfer Process]

When the driving roller 42 rotates in the transfer section 40, each of the driven roller 43 and the backup roller 44 may rotate in accordance with the rotation of the driving roller 42. This may cause the intermediate transfer belt 41 to travel in the direction indicated by the arrow F5.

The primary transfer process may involve application of a voltage to the primary transfer roller 45S. The primary transfer roller 45S may be so pressed against the photosensitive drum 312 as to be in contact with the photosensitive drum 312 with the inter mediate transfer belt 41 in between. Hence, the brilliant toner that has been attached to the surface, i.e., to the electrostatic latent image, of the photosensitive drum 312 in the foregoing developing process may be transferred onto the intermediate transfer belt 41.

### [Secondary Transfer Process]

The print medium M may pass between the backup roller 44 and the secondary transfer roller 46 upon being conveyed along the conveyance route R1.

The secondary transfer process may involve application of a voltage to the secondary transfer roller 46. The secondary transfer roller 46 may be so pressed against the backup roller 44 as to be in contact with the backup roller 44 with the print medium M in between. Hence, the brilliant toner transferred onto the intermediate transfer belt 41 in the foregoing primary transfer process may be transferred onto the print medium M.

### [Fixing Process]

After the brilliant toner has been transferred onto the print medium M in the secondary transfer process, the print medium M may be continuously conveyed along the conveyance route R1 in the direction indicated by the arrow F1. The print medium M may be thus conveyed to the fixing section 50.

The fixing process may involve a control that is so performed as to cause the surface temperature of the heating roller 51 to be a predetermined temperature. When the pressure applying roller 52 rotates while being so pressed against the heating roller 51 as to be in contact with the heating roller 51, the print medium M may be so conveyed as to pass between the heating roller 51 and the pressure applying roller 52.

The brilliant toner that has been transferred onto the print medium M may be thereby heated, which may cause the brilliant toner to be molten. Further, the molten brilliant toner may be so pressed against the print medium M while being applied with a pressure. This may cause the brilliant toner to be attached closely to the print medium M.

As a result, the brilliant toner may be fixed to the print medium M, resulting in formation of the brilliant image on the print medium M. The print medium M on which the brilliant image has been formed may be conveyed by the conveying rollers 63 and 64 along the conveyance route R2 in a direction indicated by an arrow F2. Thereafter, the print medium M may be discharged from the discharge opening 1H to the stacker 2.

### [Procedure of Conveying Print Medium]

It is to be noted that the procedure of conveying the print medium M may be varied in accordance with the form in which the brilliant image is to be formed on the print medium M.

For example, in a case where brilliant images are to be formed on both sides of the print medium M, the print medium M that has passed the fixing section 50 may be conveyed by the conveying rollers 65 to 68 along the conveyance routes R3 to R5 in directions indicated by respective arrows F3 and F4, and be thereafter conveyed again by the conveying rollers 61 and 62 along the conveyance route R1 in the direction indicated by the arrow F1. In this case, the direction in which the print medium M is to be conveyed may be controlled by the conveyance path switching guides 69 and 70. This may allow the back surface of the print medium M, i.e., the surface on which no brilliant image has been formed yet, to be subjected to the developing process, the primary transfer process, the secondary transfer process, and the fixing process.

### [Cleaning Process]

An extraneous material such as unnecessary remains of the brilliant toner may sometimes be present on the surface of the photosensitive drum 312 in the developing unit 30. The unnecessary remains of the brilliant toner may be, for example, part of the brilliant toner that has been used in the primary transfer process, which may be, for example, the brilliant toner that has remained on the surface of the photosensitive drum 312 without being transferred onto the intermediate transfer belt 41.

To address this, the photosensitive drum 312 may rotate while being so pressed against the cleaning blade 317 as to be in contact with the cleaning blade 317 in the developing unit 30. This may cause the extraneous material such as the remains of the brilliant toner present on the surface of the photosensitive drum 312 to be scraped off by the cleaning blade 317. As a result, the extraneous material may be removed from the surface of the photosensitive drum 312.

Further, in the transfer section 40, part of the brilliant toner that has been moved onto the surface of the intermediate transfer belt 41 in the primary transfer process may sometimes not be moved onto the surface of the print medium M in the secondary transfer process and may remain on the surface of the intermediate transfer belt 41.

To address this, the cleaning blade 47 may scrape off the remains of the brilliant toner present on the surface of the intermediate transfer belt 41 in the transfer section 40 upon traveling of the intermediate transfer belt 41 in the direction indicated by the arrow F5. As a result, unnecessary remains of the brilliant toner may be removed from the surface of the intermediate transfer belt 41.

### [Formation of Non-Brilliant Image]

The image forming apparatus may be able to form a brilliant image on the print medium M as described above. It is to be noted that, however, the image forming apparatus may be also able to form a non-brilliant image on the print medium M instead of the brilliant image. In this case, an operation similar to that of forming the brilliant image may be performed except that the developing units 30Y, 30M, 30C, and 30K are used instead of the developing unit 30S.

Whether each of the developing units 30Y, 30M, 30C, and 30K performs the developing process may be determined in accordance with a combination of colors necessary for forming the non-brilliant image. For example, in a case of forming a monochrome non-brilliant image, only the developing unit 30K may perform the developing process. Further, for example, in a case of forming a full-color non-brilliant image, each of the developing units 30Y, 30M, and 30C may perform the developing process in one example, or each of the developing units 30Y, 30M, 30C, and 30K may perform the developing process in another example.

### [2-4. Example Workings and Example Effects]

According to the image forming apparatus of an example embodiment of the technology, the brilliant toner described above may be mounted thereon. Accordingly, the brilliant image is formed with stability, and the quality of the brilliant image is improved. Hence, it is possible to form a higher-quality brilliant image with stability. The workings and effects described above may be obtained in a similar manner with the toner cartridge 32 that contains the brilliant toner. Further, the workings and effects described above may be obtained in a similar manner with the developing unit 30 that uses the brilliant toner.

Other example workings and other example effects related to each of the image forming apparatus, the toner cartridge 32, and the developing unit 30 may be similar to those related to the brilliant toner described above.

### 3. MODIFICATION EXAMPLES

The configuration of the image forming apparatus described above may be modified where appropriate.

### Modification Example 1

A description has been given above related to the example case where the image forming apparatus is mounted with both the brilliant toner and the non-brilliant toner; however, this is non-limiting. The type of the toner to be mounted on the image forming apparatus may be modified as desired as long as formation of the brilliant image is allowed thereby.

For example, the image forming apparatus may be mounted only with the brilliant toner and without the non-brilliant toner.

Further, in the case where the image forming apparatus is mounted with both the brilliant toner and the non-brilliant toner, the type of the non-brilliant toner may be modified as desired. In this case, the image forming apparatus directed to formation of a full-color non-brilliant image may be mounted with four types of non-brilliant toners, e.g., the yellow toner, the magenta toner, the cyan toner, and the black toner; however, this is non-limiting. In another example, the image forming apparatus directed to formation of a full-color non-brilliant image may be mounted with three types of non-brilliant toners, e.g., the yellow toner, the magenta toner, and the cyan toner. In still another example, the image forming apparatus directed to formation of a monochrome non-brilliant image may be mounted only with one type of non-brilliant toner, e.g., the black toner.

The image forming apparatus in the above-described cases also allows for formation, with the use of the brilliant toner, of higher-quality brilliant image. Hence it is possible to obtain effects similar to those described above.

### Modification Example 2

A description has been given above related to the image forming apparatus of the intermediate-transfer method that forms an image on the print medium M by means of the intermediate transfer belt 41; however, this is non-limiting. For example, the image forming apparatus may be of a direct-transfer method that forms an image on the print medium M without using the intermediate transfer belt 41, as illustrated in FIG. 4 corresponding to FIG. 2.

The image forming apparatus of the direct-transfer method may have a configuration similar to that of the image forming apparatus of the intermediate-transfer method illustrated in FIG. 2 except for the following points, for example.

Firstly, the image forming apparatus of the direct-transfer method may include, instead of the transfer section 40, five transfer rollers 48, i.e., transfer rollers 48S, 48Y, 48M, 48C, and 48K, corresponding to five primary transfer rollers 45, i.e., primary transfer rollers 45S, 45Y, 45M, 45C, and 45K. Secondly, the developing units 30, i.e., the developing units 30S, 30Y, 30M, 30C, and 30K, and the transfer rollers 48, i.e., the transfer rollers 48S, 48Y, 48M, 48C, and 48K, may be arranged along the conveyance route RI. Thirdly, the developing units 30S, 30Y, 30M, 30C, and 30K and the transfer rollers 48S, 48Y, 48M, 48C, and 48K may be disposed, for example, in this order from upstream to downstream in a direction in which the print medium M is to be conveyed along the conveyance route R1. The transfer rollers 48, i.e., the transfer rollers 48S, 48Y, 48M, 48C, and 48K may correspond to a “transfer section ” in one specific but non-limiting embodiment of the technology.

An operation of the image forming apparatus of the direct-transfer method may be, for example, similar to that of the image forming apparatus of the intermediate-transfer method except that the image forming apparatus of the direct-transfer method performs a transfer process instead of the primary transfer process and the secondary transfer process. What is performed in the transfer process may be similar to that performed in the primary transfer process. In other words, the transfer process may involve transfer, onto the print medium M, of the toner that has been attached to an electrostatic latent image in the developing process.

The image forming apparatus of the direct-transfer method described above also allows for formation, with the use of the brilliant toner, of higher-quality brilliant image with stability. Hence, it is possible to obtain effects similar to those described above. Other example workings and other example effects related to the image forming apparatus of the direct-transfer method may be similar to those related to the image forming apparatus of the intermediate-transfer method.

### [Working Examples]

A detailed description is given below of working examples of an example embodiment of the technology.

### [Experiment Examples 1-1 to 1-14]

First, the brilliant toner was manufactured. Thereafter, a brilliant image was formed with the use of the manufactured brilliant toner. Thus, a formation situation of the brilliant image and quality of the brilliant image were evaluated.

### [Manufacturing of Brilliant Toner]

The brilliant toner was manufactured by the solution suspension method by the following procedure.

### [Preparation of Oil Phase]

When the oil phase was to he prepared, 7546 parts by weight of the organic solvent, 252 parts by weight of the brilliant pigment, and 38 parts by weight of the electric charge control agent were mixed together, which was thereafter stirred. The organic solvent was ethyl acetate. The brilliant pigment was aluminum powder. The electric charge control agent was BONTRON E-84 (registered trademark) available from Orient Chemical Industries Co., Ltd., located in Osaka, Japan. The brilliant pigment was thereby dispersed in the organic solvent. As a result, the brilliant dispersion liquid was obtained.

In this case, an amount of the added brilliant pigment was so adjusted that the content of the brilliant pigment in the brilliant toner to be eventually manufactured became a predetermined value, as described in Table 1.

It is to be noted that the brilliant pigment, i.e., the aluminum powder, included a plurality of particles having respective flat shapes, i.e., a plurality of flat particles. An average thickness of the flat particles was 0.5 μm. An average length of major axes of the respective flat particles was 12 μm. An average length of minor axes of the respective flat particles was 8 μm.

Thereafter, the brilliant dispersion liquid was heated up to 60° C. while being stirred. Thereafter, 838 parts by weight of the binder resin, 38 parts by weight of the electric charge control agent, and 95 parts by weight of the release agent were mixed together. The binder resin was polyester. The electric charge control agent was a toner-dedicated resin-based electric charge control agent FCA-726N available from Fujikura Kasei Co.,Ltd., located in Tokyo, Japan. The release agent was ester wax WE-4 available from NOF Corporation, located in Tokyo, Japan. The foregoing mixture was stirred until a solid component disappeared.

in the above-described process of preparing the oil phase, a weight-average molecular weight of the brilliant toner was so adjusted that a weight-average molecular weight of the brilliant toner to be eventually manufactured became a predetermined value as described in Table 1. In this case, the weight-average molecular weight of the brilliant toner was so controlled as to have the predetermined value by varying a factor such as the type of the alcohol or the type of carboxylic acid to be used to achieve synthesis of the polyester. Specifically, bisphenol A was used as the alcohol and one or more of terephthalic acid and trimellitic acid were used as the carboxylic acid.

As a result, an oil phase including the brilliant pigment, the hinder resin, the electric charge control agent, and the release agent was obtained.

TABLE 1

| | Brilliant toner | | | | | | | |
|---|---|---|---|---|---|---|---|---|
| | | Brilliant | Weight- | Conveyance | | | | |
| | Binder | pigment | average | characteristics | | | | |
| Experiment | resin | Content | molecular | Image pattern | | | Brilliant | Electric charge |
| example | Type | (wt %) | weight | Solid | Half-tone | Glossiness | characteristics | characteristics |
| 1-1 | Polyester | 20 | 9564 | Poor | Poor | 1800 | Good | Good |
| 1-2 | | 20 | 9877 | Poor | Poor | 1623 | Good | Good |
| 1-3 | | 20 | 19601 | Poor | Good | 1450 | Good | Good |
| 1-4 | | 20 | 30436 | Good | Good | 1426 | Good | Good |
| 1-5 | | 5 | 53708 | Good | Good | 976 | Fair | Excellent |
| 1-6 | | 10 | | Good | Good | 960 | Good | Excellent |
| 1-7 | | 15 | | Good | Good | 933 | Excellent | Excellent |
| 1-8 | | 20 | | Good | Good | 768 | Excellent | Excellent |
| 1-9 | | 25 | | Good | Good | 600 | Excellent | Excellent |
| 1-10 | | 30 | | Good | Good | 597 | Excellent | Good |
| 1-11 | | 35 | | Good | Good | 594 | Excellent | Fair |
| 1-12 | | 20 | 55938 | Good | Good | 577 | Good | Good |
| 1-13 | | 20 | 80521 | Good | Good | 465 | Good | Good |
| 1-14 | | 20 | 106598 | Good | Good | 407 | Good | Good |

### [Preparation of Aqueous Phase]

When an aqueous phase was to be prepared, first, 21200 parts by weight of an aqueous medium and 738 parts by weight of an inorganic dispersant were mixed together. The aqueous medium was pure water. The inorganic dispersant was industrial trisodium phosphate 12-water. Thereafter, the mixture was heated up to 60° C. The inorganic dispersant was thereby dissolved by the aqueous medium. As a result, a first inorganic dispersion aqueous solution was obtained. Thereafter, diluted nitric acid directed to pH adjustment was added to the first inorganic dispersion aqueous solution.

Further, 3617 parts by weight of the aqueous medium and the 356 parts by weight of the inorganic dispersant were also mixed together. The aqueous medium was pure water. The inorganic dispersant was industrial calcium chloride anhydride. Thereafter, the mixture was stirred. The inorganic dispersant was thereby dissolved by the aqueous medium. As a result, a second inorganic dispersion aqueous solution was obtained.

Thereafter, the first inorganic dispersion aqueous solution and the second inorganic dispersion aqueous solution were mixed together. Thereafter, the mixture was stirred. In this case, the mixture was subjected to a stirring process while a temperature of the mixture was maintained at a high temperature which was 60° C., by means of a stirrer. The stirrer was a continuous pulverizer line mill available from Primix Corporation, located in Hyogo, Japan. The stirring process was performed at a rotation speed of 3566 rpm for 34 minutes.

As a result, an aqueous phase including the aqueous medium and the inorganic dispersant was obtained.

### [Granulation]

When granulation was to be performed with the use of the oil phase and the aqueous phase, first, the aqueous phase at 60° C. and the oil phase were mixed together. Thereafter, the mixture was stirred. In this case, a mixture ratio by weight between the aqueous phase and the oil phase was 3:1. Further, the mixture was subjected to a stirring process by means of the foregoing stirrer. The stirring process was performed at a rotation speed of 1000 rpm for 5 minutes. The mixture phase was thereby suspended and granulated. As a result, slurry including a plurality of toner base particles was obtained.

Thereafter, the slurry was distilled under a reduced pressure. The organic solvent was thereby volatilized and removed. Thereafter, a pH regulator was so added to the slurry that the pH of the slurry was adjusted to be equal to or lower than 1.6. The pH regulator was nitric acid. The inorganic dispersant was thereby dissolved and removed. Thereafter, the slurry was dehydrated. The toner base particles were thereby collected from the slurry. Thereafter, the collected toner base particles were re-dispersed in pure water, and the pure water with the toner base particles was stirred thereafter. Thereafter, the toner base particles were dehydrated and dried. Thereafter, the toner base particles dehydrated and dried were classified.

### [External Addition Process]

When the external addition process was to be performed, 100 parts by weight of the toner base particles and 11.9 parts by weight of the external additive, i.e., a plurality of hydrophobic particles, were mixed together. Thereafter, the mixture was stirred. As the external additive, a mixture of 4.9 parts by weight of silica powder and 7 parts by weight of colloidal silica was used. The silica powder was hydrophobic silica RY200 having an average primary particle size of 12 μm available from Nippon Aerosil Co., Ltd., located in Tokyo, Japan. The colloidal silica was sol-gel silica X24-9163A having an average primary particle size of 100 nm available from Shin-Etsu Chemical Co., Ltd., located in Tokyo, Japan. In this case, the mixture was subjected to a stirring process by means of a stirrer. The stirring process was performed at a rotation speed of 5400 rpm for 10 minutes. The stirrer was Henschel mixer with a working capacity of 7 liters available from Nippon Coke & Engineering Co., Ltd., located in Tokyo, Japan.

The external additive was thereby fixed onto the surfaces of the toner base particles. As a result, the brilliant toner was obtained. The obtained brilliant toner did not include any colorant, and was therefore a silver brilliant toner.

### [Formation of Brilliant Image]

Brilliant images were formed, by the following procedure, on the print medium M by means of the image forming apparatus mounted with the brilliant toner.

A color printer MICROLINE VINCI C941 available from Oki Data Corporation, located in Tokyo, Japan, was used as the image forming apparatus, and printer paper of A4 size, “Excellent Gloss” having a size of 297 mm×210 mm, available from Oki Data Corporation, located in Tokyo, Japan, was used as the print medium M. As environmental conditions, the temperature was set to 23° C., and the humidity was set to 50%.

When the brilliant images were to be formed on the print medium M, the brilliant images were formed, with use of the brilliant toner, on the basis of a solid image pattern at a printing rate of 100% on respective five hundred sheets of the print medium M in succession. Further, the brilliant images were formed, with the use of the brilliant toner, on the basis of a half-tone image pattern at a printing rate of 25% on another respective five hundred sheets of the print medium M in succession.

### [Evaluation of Formation Situation and Quality of Brilliant Image]

Formation situation and quality of each of the brilliant images were evaluated by the following procedure.

In order to evaluate the formation situation of each of the brilliant images, conveyance characteristics of the print medium M at the time of forming the brilliant image based on the solid image pattern and the brilliant image based on the half-tone image pattern were visually examined. As a result of the visual examination, a case was determined “good” where the brilliant toner was not attached around the component such as the heating roller 51 in the fixing section 50 and the print medium M was therefore conveyed with stability. In contrast, a case was determined “poor” where the brilliant toner was attached around the component in the fixing section 50 and it was therefore more difficult for the print medium M to be conveyed with stability.

In order to evaluate the quality of each of the brilliant images, glossiness of the brilliant image based on the solid image pattern was examined. In this case, a gloss level of the brilliant image was measured by means of a gloss meter. As the gloss meter, a variable angle photometer GC-5000L available from Nippon Denshoku Industries Co., Ltd., located in Tokyo, Japan was used. As the gloss level of the brilliant image, regular a reflection rate was measured under conditions where an incident angle was 45° and a reflection angle was 135°.

Further, in order to evaluate the quality of each of the brilliant images, the brilliant characteristics of the brilliant image were visually examined. As a result of the visual examination, a case was determined “excellent” where the surface of the brilliant image was extremely brilliant. A case was determined “good” where the surface of the brilliant image was sufficiently brilliant and the brilliance of the surface of the brilliant image was within an acceptable range. A case was determined “fair” where the surface of the brilliant image was not sufficiently brilliant but obvious brilliance was visually confirmed on the basis of comparison between the brilliant image and a non-brilliant image.

Further, in order to evaluate the quality of each of the brilliant images, electric charge characteristics of the brilliant image were visually examined. As a result of the visual examination, a case was determined “excellent” where an electric charge amount was sufficient, and therefore, a so-called fog phenomenon did not occur. A case was determined “good” where the fog phenomenon occurred as a result of an insufficient electric charge amount but the occurrence of the fog phenomenon was in an extremely small range and was hardly confirmed visually. A case was determined as “fair” where the fog phenomenon occurred as a result of a further insufficient electric charge amount but the occurrence of the fog phenomenon was in an acceptable range.

### [Discussion]

As can be appreciated from Table 1, both the conveyance characteristics and the glossiness were varied greatly in accordance with the weight-average molecular weight of the brilliant toner.

Specifically, in a case where the weight-average molecular weight of the brilliant toner was smaller than 19601, i.e., in Experiment Examples 1-1 and 1-2, the conveyance characteristics were “poor” independently of the image pattern. In contrast, in a case where the weight-average molecular weight of the brilliant toner was equal to or greater than 19601, i.e., in Experiment Examples 1-3 to 1-14, the conveyance characteristics were improved, depending on the image pattern, compared with the above-described case where the weight-average molecular weight of the brilliant toner was smaller than 19601. Specifically, the conveyance characteristics were “good” in a case where the brilliant image was based on the half-tone image pattern.

It is to be noted that, in a case where the weight-average molecular weight of the brilliant toner was 19601, i.e., in Experiment Example 1-3, the conveyance characteristics were “poor” when the brilliant image was based on the solid image pattern. However, the condition based on the solid image pattern is the most difficult condition for evaluation of the conveyance characteristics. Therefore, when the conveyance characteristics of the brilliant image based on the solid image pattern are “poor” but the conveyance characteristics of the brilliant image based on an image pattern other than the solid image pattern, i.e., the half-tone image pattern in the above-described Experiment Examples, are “good”, the conveyance characteristics of “good” are obtainable in a case of forming a usual image as the brilliant image. The usual image may be, for example, an image other than a solid image

Moreover, in a case where the weight-average molecular weight of the brilliant toner was greater than 55938, i.e., in Experiment Examples 1-13 and 1-14, the gloss level was lower than 500. Therefore, a sufficient gloss level was not obtained. In contrast, in a case where the weight-average molecular weight of the brilliant toner was equal to or smaller than 55938, i.e., in Experiment Examples 1-1 to 1-12. the gloss level was equal to or higher than 500. Therefore, a sufficient gloss level was obtained.

Accordingly, in a case where the weight-average molecular weight of the brilliant toner was equal to or greater than 19601 and equal to or smaller than 55938, both superior conveyance characteristics and superior glossiness were obtained. Therefore, conveyance characteristics and glossiness were both achieved.

In particular, the following tendencies were obtained in the case where the weight-average molecular weight of the brilliant toner was equal to or greater than 19601 and equal to or smaller than 55938, i.e., in Experiment Examples 1-3 to 1-12.

Firstly, in a case where the weight-average molecular weight of the brilliant toner was smaller than 30436, i.e., in Experiment Example 1-3, the conveyance characteristics of the brilliant image based on the half-tone image pattern were “good” but the conveyance characteristics of the brilliant image based on the solid image pattern were “poor” as described above. In contrast, in a case where the weight-average molecular weight of the brilliant toner was equal to or greater than 30436, i.e., in Experiment Examples 1-4 to 1-11, the conveyance characteristics of the brilliant image based on the half-tone image pattern were “good” and the conveyance characteristics of the brilliant image based on the solid image pattern were also “good”. Accordingly, in the case where the weight-average molecular weight of the brilliant toner was equal to or greater than 30436 and equal to or smaller than 55938, the conveyance characteristics were “good” independently of the image pattern.

Secondly, in a case where the content of the brilliant pigment was smaller than 10 wt %, i.e., in Experiment Example 1-5, the brilliant characteristics were “fair”. In a case where the content of the brilliant pigment was equal to or greater than 10 wt %, i.e., in Experiment Examples 1-6 to 1-11, the brilliant characteristics were “good” or “excellent”. In this case, when the content of the brilliant pigment was equal to or greater than 15 wt %, i.e., in Experiment Examples 1-7 to 1-11, the brilliant characteristics were “excellent”.

Thirdly, in a case where the content of the brilliant pigment was greater than 30 wt %, i.e., in Experiment Example 1-11, the electric charge characteristics were “fair”. In a case where the content of the brilliant pigment was equal to or smaller than 30 wt %, i.e., in Experiment Examples 1-5 to 1-10, the electric charge characteristics were “good” or “excellent”. In this case, when the content of the brilliant pigment was equal to or smaller than 25 wt %, i.e., in Experiment Examples 1-5 to 1-9, the electric charge characteristics were “excellent”.

Fourthly, as can be appreciated from the above-described results related to the brilliant characteristics and the electric charge characteristics, in a case where the content of the brilliant pigment was equal to or greater than 10 wt % and equal to or smaller than 30 wt %, both superior brilliant characteristics and superior electric charge characteristics were obtained. Therefore, both brilliant characteristics and electric charge characteristics were achieved. In this case, when the content of the brilliant pigment was equal to or greater than 15 wt % and equal to or smaller than 25 wt %, further superior brilliant characteristics were obtained and further superior electric charge characteristics were also obtained. Therefore, both the brilliant characteristics and the electric charge characteristics were further improved.

### [Experiment Examples 2-1 to 2-8]

For comparison, the non-brilliant toner, specifically, the magenta toner, was manufactured. Thereafter, non-brilliant images were formed with the use of the manufactured non-brilliant toner. The formation situation and the quality of each of the formed non-brilliant images were thereby evaluated. The evaluated quality of the non-brilliant images included conveyance characteristics and glossiness thereof.

### [Manufacturing of Non-Brilliant Toner]

When the non-brilliant toner was to be manufactured, a procedure similar to that of the method of manufacturing the brilliant toner, i.e., the solution suspension method, was performed except that the non-brilliant pigment was used instead of the brilliant pigment. The used non-brilliant pigment was quinacridone which was the magenta pigment. In this case, as described in Table 2, an amount of the added non-brilliant pigment was so adjusted that the content of the non-brilliant pigment in the non-brilliant toner to be eventually manufactured became 5 wt %. Further, a weight-average molecular weight of the non-brilliant toner was so adjusted that a weight-average molecular weight of the non-brilliant toner to be eventually manufactured became a predetermined value as described in Table 2. This adjustment of the weight-average molecular weight of the non-brilliant toner was performed by a method similar to that in the case of manufacturing the brilliant toner.

TABLE 2

| | Non-brilliant toner | | | | | |
|---|---|---|---|---|---|---|
| | | Non- | | Conveyance | | |
| | | brilliant | Weight- | characteristics | | |
| | Binder | pigment | average | Image pattern | | |
| Experiment | resin | Content | molecular | | Half- | Glossi- |
| example | Type | (wt %) | weight | Solid | tone | ness |
| 2-1 | Poly- | 5 | 9564 | Good | Good | 2176 |
| 2-2 | ester | 5 | 9877 | Good | Good | 1999 |
| 2-3 | | 5 | 19601 | Good | Good | 1826 |
| 2-4 | | 5 | 30436 | Good | Good | 1802 |
| 2-5 | | 5 | 53708 | Good | Good | 953 |
| 2-6 | | 5 | 55938 | Good | Good | 976 |
| 2-7 | | 5 | 80521 | Good | Good | 841 |
| 2-8 | | 5 | 106598 | Good | Good | 783 |

### [Formation of Non-Brilliant Image]

The non-brilliant images based on the solid image pattern and the half-tone image pattern were formed on the print medium M by means of the image forming apparatus mounted with the non-brilliant toner. This formation of the non-brilliant images was performed by a procedure similar to that in the case of forming the brilliant images except that the non-brilliant toner was used instead of the brilliant toner.

### [Evaluation of Formation Situation and Quality of Non-Brilliant Image]

The formation situation and the quality of each of the formed non-brilliant image were evaluated by procedures similar to those in the case of evaluating the formation situation and the quality of each of the brilliant images except that the non-brilliant images were formed instead of the brilliant images. The evaluated quality of the non-brilliant images included conveyance characteristics and glossiness thereof.

### [Discussion]

As can be appreciated from Table 2, tendencies obtained in the case of forming the non-brilliant images with the use of the non-brilliant toner were different from those in the case described in Table 1 of forming the brilliant images with the use of the brilliant toner.

Specifically, the conveyance characteristics were “good” independently of the weight-average molecular weight of the non-brilliant toner. Further, the glossiness was equal to or higher than 500 independently of the weight-average molecular weight of the non-brilliant toner, and therefore “good”. In other words, both superior conveyance characteristics and superior glossiness were obtained independently of the weight-average molecular weight of the non-brilliant toner.

In the case of forming the brilliant images with the use of the brilliant toner described in Table 1, superior conveyance characteristics or superior glossiness were not obtained unless the weight-average molecular weight of the brilliant toner was made appropriate. In contrast, in the case of forming the non-brilliant images with the use of the non-brilliant toner described in Table 2, both superior conveyance characteristics and superior glossiness were obtained also when the weight-average molecular weight of the brilliant toner was not made appropriate.

As can be appreciated from the difference in tendencies described above, issues that should be improved related to each of the conveyance characteristics and the glossiness are unique to the case of using the brilliant toner.

For example, in the case of using the non-brilliant toner, i.e., in the case of using the non-brilliant pigment having a smaller nanometer-order particle size, it is more difficult for the interface between the non-brilliant pigment and the binder resin to break. Further, brilliant characteristics are not required in such a case. Therefore, the conveyance characteristics and the glossiness are less influenced by the weight-average molecular weight of the toner.

In contrast, in the case of using the brilliant toner, i.e., in the case of using the brilliant pigment having a greater micrometer-order particle size, it is easier for the interface between the brilliant pigment and the binder resin to break, as described above. Further, brilliant characteristics are required in such a case. Therefore, the conveyance characteristics and the glossiness are more influenced by the weight-average molecular weight of the toner.

Accordingly, the appropriate range of the weight-average molecular weight of the toner described above, which is equal to or greater than about 19601 and equal to or smaller than about 55938, is a special condition that provides unique advantages when applied to the brilliant toner but is meaningless when applied to the non-brilliant toner. Non-limiting examples of the foregoing unique advantages may include improvement in each of the conveyance characteristics and the glossiness.

As can be appreciated from the results described in Tables 1 and 2, when the weight-average molecular weight of the brilliant toner including the brilliant pigment and the binder resin was equal to or greater than 19601 and equal to or smaller than 55938, both the conveyance characteristics and the glossiness were improved. Accordingly, a higher-quality brilliant image was allowed to be formed with stability.

Some example embodiments and the modification examples thereof of the technology have been described above; however, embodiments of the technology are not limited to the example embodiments and the modification examples described above, and is modifiable in various ways.

For example, the image forming apparatus according to one embodiment of the technology is not limited to a printer, and may be any other apparatus such as a copying machine, a facsimile, or a multi-functional peripheral.

Furthermore, the technology encompasses any possible combination of some or all of the various embodiments and the modifications described herein and incorporated herein. It is possible to achieve at least the following configurations from the above-described example embodiments of the technology.

(1)

A toner including:

a brilliant pigment; and

binder resin,

the toner having a weight-average molecular weight that is equal to or greater than 19601 and equal to or smaller than 55938.

(2)

The toner according to (1), in which the weight-average molecular weight of the toner is equal to or greater than 30436 and equal to or smaller than 55938.

(3)

The toner according to (1) or (2), in which the brilliant pigment includes a plurality of flat particles.

(4)

The toner according to (3), in which

the flat particles of the brilliant pigment have respective major axes and respective minor axes,

an average thickness of the flat particles of the brilliant pigment is equal to or greater than 0.1 micrometers and equal to or smaller than 1 micrometer,

an average length of the major axes is equal to or greater than 5 micrometers and equal to or smaller than 20 micrometers, and

an average length of the minor axes is equal to or greater than 2 micrometers and equal to or smaller than 12 micrometers.

(5)

The toner according to any one of (1) to (4), in which a content of the brilliant pigment is equal to or greater than 10 weight percent and equal to or smaller than 30 weight percent.

(6)

The toner according to any one of (1) to (5), in which the binder resin includes polyester.

(7)

The toner according to any one of (1) to (6), in which the brilliant pigment includes aluminum, a pearlescent pigment, or both.

(8)

A toner container including a toner containing unit that contains the toner according to any one of (1) to (7).

(9)

A developing unit including:

the toner container according to (8); and

a developing process unit that performs a developing process with use of the toner contained in the toner container.

(10)

An image forming apparatus including:

the developing unit according to (9);

a transfer section that performs a transfer process with use of the toner on which the developing process has been performed by the developing unit; and

a fixing section that performs a fixing process with use of the toner on which the transfer process has been performed by the transfer section.

(11)

A method of manufacturing a toner, the method including:

preparing an oil phase including a brilliant pigment, binder resin, and an organic solvent;

preparing an aqueous phase including an inorganic dispersant and an aqueous medium;

performing granulation of a toner base particle by mixing the oil phase and the aqueous phase; and

manufacturing the toner with use of the toner base particle, the toner having a weight-average molecular weight that is equal to or greater than 19601 and equal to or smaller than 55938.

According to any of the toner, the toner container, the developing unit, the image forming apparatus, and the method of manufacturing the toner of one embodiment of the technology, the weight-average molecular weight of the toner including the brilliant pigment and the binder is equal to or greater than about 19601 and equal to or smaller than about 55938. Hence, it is possible to form, with stability, a higher-quality image having brilliant characteristics.

Although the technology has been described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. The term “substantially” and its variations are defined as being largely but not necessarily wholly what is specified as understood by one of ordinary skill in the art. The term “about” or “approximately” as used herein can allow for a degree of variability in a value or range. Moreover, no element or component in this disclosure is intended to be dedicated to the public regardless of whether the element or component is explicitly recited in the following claims.

What is claimed is:

1. A toner comprising:
a brilliant pigment; and
binder resin,
the toner having a weight-average molecular weight that is equal to or greater than 19601 and equal to or smaller than 55938.

2. The toner according to claim 1, wherein the weight-average molecular weight of the toner is equal to or greater than 30436 and equal to or smaller than 55938.

3. The toner according to claim 1, wherein the brilliant pigment comprises a plurality of flat particles.

4. The toner according to claim 3, wherein
the flat particles of the brilliant pigment have respective major axes and respective minor axes,
an average thickness of the flat particles of the brilliant pigment is equal to or greater than 0.1 micrometers and equal to or smaller than 1 micrometer,
an average length of the major axes is equal to or greater than 5 micrometers and equal to or smaller than 20 micrometers, and
an average length of the minor axes is equal to or greater than 2 micrometers and equal to or smaller than 12 micrometers.

5. The toner according to claim 1, wherein a content of the brilliant pigment is equal to or greater than 10 weight percent and equal to or smaller than 30 weight percent.

6. The toner according to claim 1, wherein the binder resin includes polyester.

7. The toner according to claim 1, wherein the brilliant pigment includes aluminum, a pearlescent pigment, or both.

8. A toner container comprising a toner containing unit that contains the toner according to claim 1.

9. A developing unit comprising:
the toner container according to claim 8; and
a developing process unit that performs a developing process with use of the toner contained in the toner container.

10. An image forming apparatus comprising:
the developing unit according to claim 9;
a transfer section that performs a transfer process with use of the toner on which the developing process has been performed by the developing unit; and
a fixing section that performs a fixing process with use of the toner on which the transfer process has been performed by the transfer section.

11. A method of manufacturing a toner, the method comprising:
preparing an oil phase including a brilliant pigment, binder resin, and an organic solvent;
preparing an aqueous phase including an inorganic dispersant and an aqueous medium;
performing granulation of a toner base particle by mixing the oil phase and the aqueous phase; and
manufacturing the toner with use of the toner base particle, the toner having a weight-average molecular weight that is equal to or greater than 19601 and equal to or smaller than 55938.
